(19) United States
(12) Patent Application Publication
(10) Pub. No.: US 2002/0110220 A1
(43) Pub. Date: Aug. 15, 2002

(54) Method and apparatus for delivering localized X-ray radiation to the interior of a body

(76) Inventors: Zilan Shen, West Windsor, NJ (US); Jia Ming Chen, Plainsboro, NJ (US); Heinz Hermann Busta, Park Ridge, IL (US); Steven Alan Lipp, Cranbury, NJ (US)

Correspondence Address: MOSER, PATTERSON & SHERIDAN, LLP, /SARNOFF CORPORATION, 595 SHREWSBURY AVENUE, SUITE 100, SHREWSBURY, NJ, 07702, US

(21) Appl. No.: 09/989,746

(22) Filed: Nov. 20, 2001

Related U.S. Application Data
(60) Provisional application No. 60/252,709, filed on Nov. 22, 2000.
(60) Provisional application No. 60/289,164, filed on May 7, 2001.

(51) Int. Cl. H01J 35/08

(52) U.S. Cl. 378/124; 378/92

(57) ABSTRACT

A method and apparatus for delivering localized x-ray radiation to the interior of a body includes a plurality of x-ray sources disposed in a distal portion of a flexible catheter shaft. The plurality of x-ray sources are secured to a flexible cord disposed longitudinally throughout at least a portion of the shaft. The plurality of x-ray sources are electrically coupled to a control circuit for activating specific ones of the plurality of x-ray sources in order to customize the irradiation of the interior of the body.

### CROSS-REFERENCE TO RELATED APPLICATIONS

This application claims benefit of U.S. provisional patent applications serial No. 60/252,709, filed Nov. 22, 2000, and Ser. No. 60/289,164, filed May 7, 2001, which are both herein incorporated by reference.

### BACKGROUND OF THE INVENTION

1. Field of the Invention

The present invention generally relates to X-ray catheters and, more particularly, to a flexible chain of x-ray sources disposed in a catheter for controlled delivery of localized x-ray radiation to areas in the interior of a body where radiation is required.

2. Description of the Related Art

Cardiovascular diseases affect millions of people, often causing heart attacks and death. One common aspect of many cardiovascular diseases is stenosis, or the thickening of the artery or vein, which decreases blood flow through the vessel. Angioplasty procedures have been developed to reopen clogged arteries without resorting to a bypass operation. In a large percentage of cases, however, arteries become occluded again after an angioplasty procedure. This recurrent thickening of the vessel is termed restenosis. Restenosis of an artery or vein after percutaneous transluminal coronary angioplasty (PTCA) or percutaneous transluminal angioplasty (PTA) occurs in about one-third of the procedures, requiring the procedure to be repeated and eventually requiring bypass surgery. Bypass surgery is very stressful on the patient, requiring the chest to be opened, and presents risks from infection, anesthesia, and heart failure.

Effective methods of preventing or treating restenosis could benefit millions of people. One approach uses drug therapy to prevent or minimize restenosis. Another approach involves beta-irradiation of the vessel wall by positioning radioactive isotopes in the vessel at the site of the restenosis. Drugs delivered to the site of an angioplasty procedure, however, can be rapidly dissipated and removed from the site before they can be sufficiently absorbed to be effective. As for beta irradiation, the depth of the penetration of the radiation is impossible to control and the radioactive source will also irradiate other healthy parts of the body as it is brought to the site to be treated. In addition, medical personnel must take extensive precautions when handling radioactive material.

Therefore, there exists a need in the art for a method and apparatus for controlled delivery of localized radiation to the interior of a body only in areas where radiation is required.

### SUMMARY OF THE INVENTION

The disadvantages associated with the prior art are overcome by a method and apparatus for delivering localized x-ray radiation to the interior of a body that comprises a plurality of x-ray sources disposed in a distal portion of a flexible catheter shaft. In one embodiment of the invention, the plurality of x-ray sources are secured to a flexible cord disposed longitudinally throughout the shaft via clip-on connections. The clip-on connections also provide electrical connections between electrical lines embedded in the flexible cord and each of the x-ray sources. Furthermore, the plurality of x-ray sources are electrically coupled to a bus line circuit for activating specific ones of the plurality of x-ray sources in order to customize the irradiation of the interior of the body.

### BRIEF DESCRIPTION OF THE DRAWINGS

So that the manner in which the above recited features of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 depicts a high level schematic diagram of an x-ray catheter device of the present invention;

FIG. 2 is a cross-sectional view and block diagram showing one embodiment of an x-ray catheter device of the present invention;

FIG. 3 is a side view of a portion of a flexible cord showing a flexible extension before attachment of an x-ray source;

FIG. 4 shows a front view of the flexible extension;

FIG. 5 is a cross-sectional view showing one example of the x-ray source shown in FIG. 2;

FIG. 6 is an exploded view showing a method of batch packaging the x-ray source of FIG. 5;

FIG. 7 is a schematic diagram showing an alternative configuration of an x-ray source;

FIG. 8 is a block diagram of a getter activation circuit for use with an x-ray source;

FIG. 9 depicts a block diagram of the electrical bus line circuit of FIG. 2;

FIG. 10 is a cross-sectional view of an x-ray source in a catheter that employs flashover protection;

FIG. 11 is a graph illustrating a method of driving an x-ray source to reduce flashover;

FIG. 12 is an isometric view of an alternative embodiment of an x-ray source of the present invention;

FIG. 13 is a cross-sectional view showing an alternative embodiment of an x-ray source chain of the present invention;

FIG. 14 is a top plan view of the x-ray source chain of FIG. 13;

FIGS. 15-17 show a method of batch packaging the x-ray sources of FIGS. 12-14.

### DETAILED DESCRIPTION OF THE PREFERRED EMBODIMENT

The present invention is applicable to a variety of devices, systems, and arrangements that irradiate arteries, vessels, or interior sites in a body with x-ray radiation. Specifically, in accordance with one aspect of the present invention, a flexible chain of x-ray sources is disposed in a catheter for delivering localized x-ray radiation to areas in the interior of the body. As described below, each of the x-ray sources in the flexible chain are capable of being individually activated so as to provide customizable irradiation only to those areas in the interior of the body where radiation is required. The present invention is particularly advantageous in preventing restenosis in the cardiovascular system. Those skilled in the art, however, will appreciate that the present invention can be useful in other applications requiring the delivery of radiation to interior sites in a body.

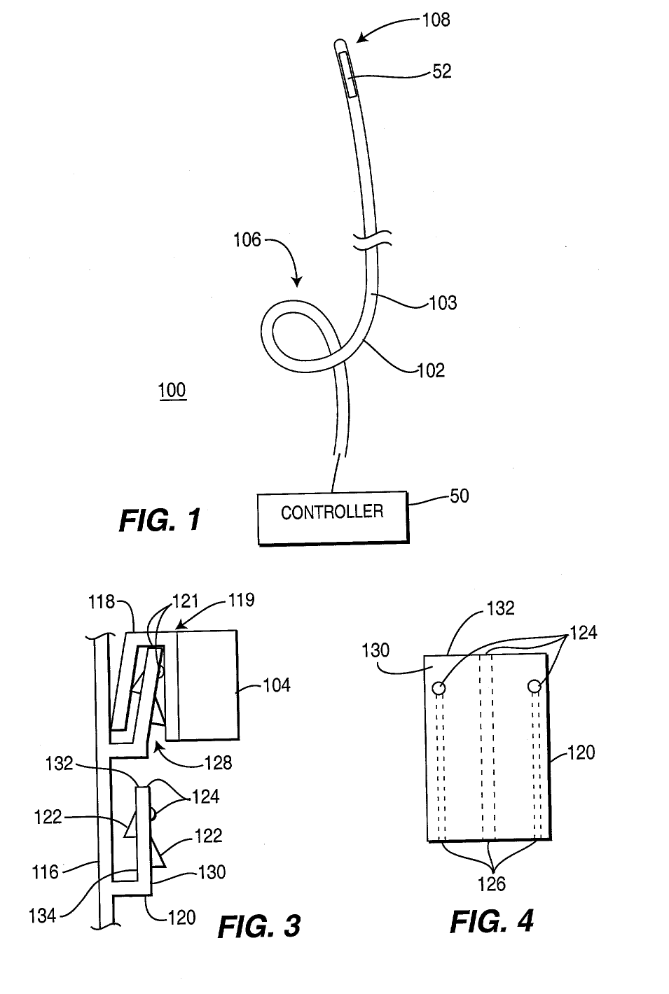

FIG. 1 depicts a high level schematic diagram of an x-ray catheter device 100 of the present invention. The device 100 comprises a flexible catheter shaft 102 adapted for insertion into blood vessels or body cavities, an x-ray radiation source 52, and a controller 50. The shaft 102 comprises, for example, polyethylene, polyurethane, polyether block amide, nylon 12, polyamide, polyamide copolymer, polypropylene, polyester copolymer, polyvinyl difluoride, or silicon rubber. The shaft 102 includes a lumen 103 extending longitudinally therethrough, and has a proximal portion 106 and a distal portion 108. The x-ray radiation source 52 is generally disposed in the lumen 103 along the distal portion 108. Controller 50 activates and deactivates the x-ray radiation source 52. In coronary applications, the device 100 can be inserted in the body at the femoral artery and threaded through a network of blood vessels until the distal portion 108 of the shaft 102 reaches the heart, as is well known in the art.

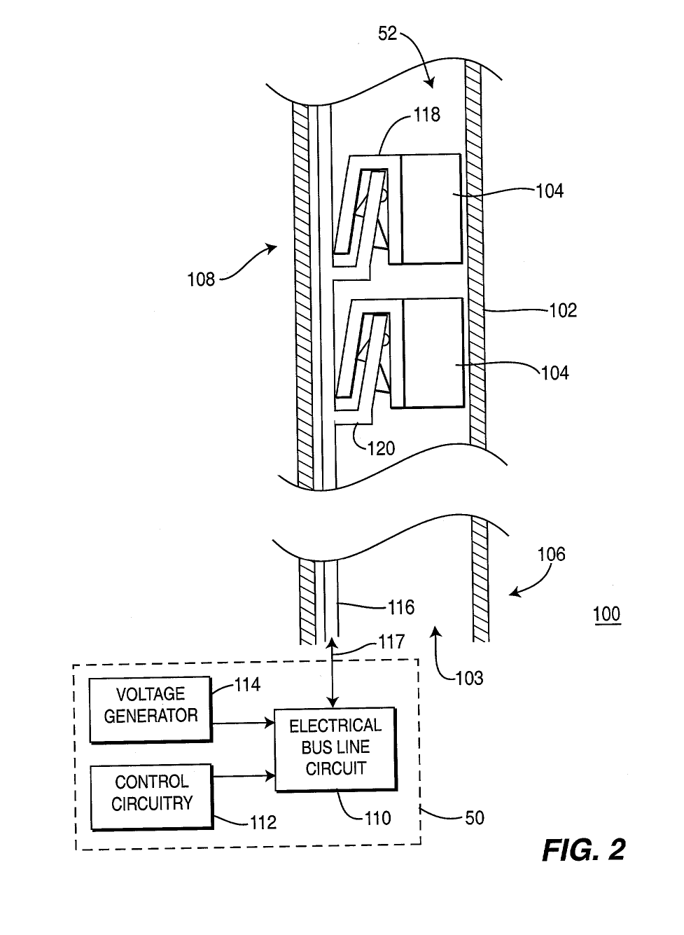

FIG. 2 is a cross-sectional view and block diagram showing one embodiment of the x-ray catheter device 100 of the present invention. In present embodiment, the device 100 comprises a plurality of x-ray sources 104, an electrical bus line circuit 110, a voltage generator 114, and control circuitry 112. The plurality of x-ray sources 104 are generally disposed in the lumen 103 along the distal portion 108.

The plurality of x-ray sources 104 are mechanically and electrically coupled to a flexible cord 116. The flexible cord 116 comprises a flexible dielectric material, such as plastic, which is hydrophobic to enhance water sealing. The flexible cord 116 includes electrical lines 117 embedded in the dielectric material. The electrical lines 117 couple the electrical bus line circuit 110 and the voltage generator 114 to each of the plurality of x-ray sources 104. The number of electrical lines 117 depends on the number of electrical connections needed for each x-ray source 104 and the number of control lines needed for the electrical bus line circuit. For example, the x-ray sources 104 may require two to three electrical connections and the electrical bus line circuit 110 may require two control lines, giving rise to a total of four or five electrical lines. Those skilled in the art will appreciate that there are various configurations of electrical lines 117 within the scope of the present invention.

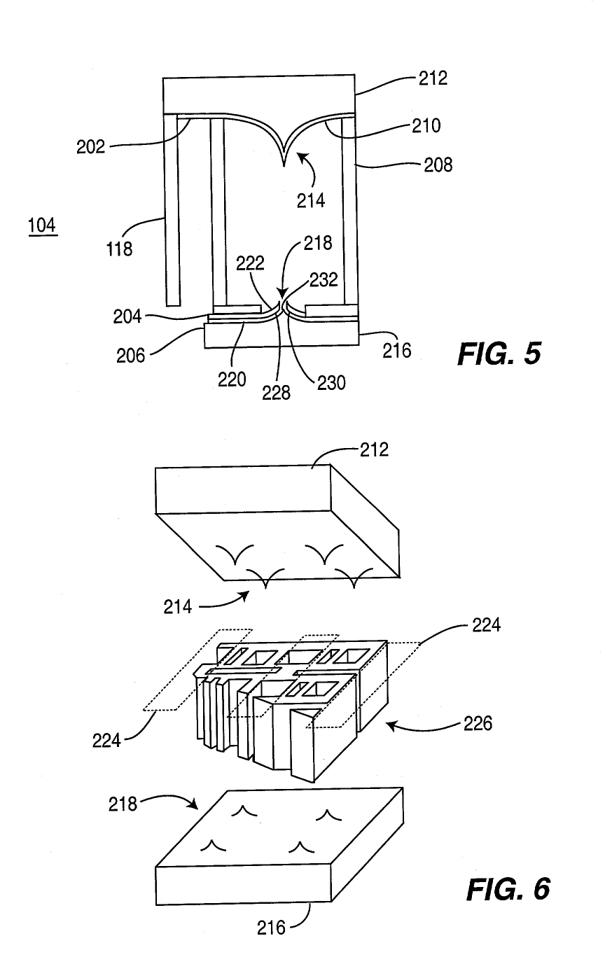

The electrical bus line circuit 110 is further coupled to the voltage generator 114 and the control circuitry 112. The voltage generator 114 preferably operates in the 0-30 kilovolt (kV) range. In operation, the voltage generator 114 produces power signals necessary to operate each of the plurality of x-ray sources 104. The electrical bus line circuit 110 and control circuitry 112 provide the control necessary to individually activate specific ones of the plurality of x-ray sources 104 as required. An example of the electrical bus line circuit 110 is described below with respect to FIG. 5.

The plurality of x-ray sources 104 are mechanically coupled to the flexible cord 116 via “clip-on” connectors 119. Specifically, the flexible cord 116 includes a flexible extension 120 for each of the plurality of x-ray sources 104. Each flexible extension is formed of the same or similar material as that of the flexible cord 116 (e.g., plastic). FIG. 3 is a side view of a portion of the flexible cord 116 showing one of the flexible extensions 120 before attachment of the x-ray source. FIG. 4 shows a front view of the flexible extension 120. As shown in FIGS. 3 and 4, each flexible extension 120 is cantilevered from the flexible cord 116 and has a front face 130, a rear face 134, and a top face 132. Each flexible extension 120 further includes a plurality of conductive contacts 124 (one for each electrical connection on the x-ray source, for example, three are shown), an electrical line extension 126 for each contact 124, and a plurality of protrusions 122 (e.g., two are shown). The plurality of contacts 124 are disposed so as to contact the electrical contact pads 121 present on the x-ray source. In the present example, two electrical contacts 124 are disposed on the front face 130, and one electrical contact 124 is disposed on the top face 132. The electrical line extensions 126 couple the electrical lines 117 to the contacts 124, and are embedded within the flexible extension 120. Those skilled in the art can appreciate that various other contact configurations as are necessary for a particular x-ray source are within the scope of the present invention.

Each x-ray source 104 is mounted to a clip 118 formed of a relatively flexible dielectric material, such as a thin sheet of quartz. The clip 118 of each x-ray source mates with one of the flexible extensions 120 in order to secure the x-ray source to the flexible cord 116. More specifically, the protrusions 122 are disposed on the front and back faces 130 and 134 of the flexible extension 120 and create a mechanical force on the clip 118, which both secures the x-ray source 104 in place and creates a conductive path between the contacts 124 and the electrical pads 121 on the x-ray source 104. The interior portion 128 of the clip-on connector 119 is filled with a dielectric material, such as plastic (not shown), in order to seal the contacts 124 from the ambient to prevent electrical breakdown between the contacts 124 and the ambient (known in the art as flashover).

In this manner, the present invention provides a flexible chain of x-ray sources, where specific x-ray sources on the chain can be independently activated to customize the irradiation of only those areas where radiation is required. The present invention thereby emulates a chain of radioactive seeds while avoiding the attendant drawbacks inherent in beta irradiation procedures. That is, the x-ray sources only irradiate when activated, reducing radiation exposure to patients and medical staff. Moreover, the present invention can reduce the surgical procedure time by irradiating a larger area of a lumen simultaneously, which works to prevent neointimal formation after a vascular intervention, for example.

FIG. 5 is a cross-sectional view of one example of an x-ray source 104 shown in FIG. 2. The x-ray source 104 is a miniature electrically activated, vacuum sealed, microelectronic mechanical system (MEMS) x-ray device that can be fabricated using a batch packaging process as shown in FIG. 6. The x-ray source 104 comprises an anode layer 212 and an emitter layer 216 (also known as a cathode layer) separated from each other by a spacer (walls 208), and a getter 210. The anode layer 212 comprises a cylindrically symmetric anode 214 formed on a silicon substrate. Alternatively, a simpler anode 214 without the cylindrically symmetric etch profile can be used. The emitter layer 216 comprises a cone-shaped emitter 218, an insulating layer 220 that is opened at the location of the emitter 218, and a gate 222 that is also opened at the location of the emitter 218 and is isolated from the emitter 218 by the insulating layer 220, all formed on a silicon substrate. The anode 214 comprises a heavy metal, such as tungsten. The emitter 218 is formed of silicon or carbon based film. The insulating layer 220 typically comprises silicon dioxide and the gate 222 comprises, for example, a molybdenum thin-film. The gate 222 is constructed so that it overhangs the edge 228 of the insulating layer 220 and droops towards the emitter 218. Thus, insulating layer 220 defines a first aperture 230 and gate 222 defines a second aperture 232, where the first and second apertures are substantially concentric with the emitter 218.

The clip 118 is bonded to the anode layer 212. The clip 118 comprises a thin dielectric material, such as quartz, that is relatively flexible for clipping onto the flexible extensions 120, as described above. Electrodes 202, 204, and 206 comprise deposited metal lines, such as aluminum or gold lines, that are conductively coupled to the anode 214, the gate 222, and the emitter 218, respectively. Alternatively, electrodes 202, 204, and 206 can be wire bonded to the anode 214, the gate 222, and the emitter 218, respectively.

In operation, the space between the anode layer 212 and the emitter layer 216 is held under a vacuum, which is maintained by the walls 208. When the x-ray source 104 is to be activated, the getter 210 can be electrically activated to improve the vacuum, as is well known in the art. The getter 210 comprises a thin film of getter material, such as barium, that is deposited over the anode layer 212 or the emitter layer 216. One method for activating the getter is described below with respect to FIG. 8. The getter 210 is activated to improve the vacuum, and eventually evaporates from the anode 214. The anode 214 is kept at a high voltage (e.g., 10 to 20 kV) with respect to the emitter 218. When the x-ray source 104 is to be activated, a voltage potential between 10 and 100V is applied to the gate 222 to create an electric field strong enough for electrons to leave the emitter 218 and travel toward the anode 214. When the electrons strike the anode 214, x-ray radiation is emitted in a known manner.

FIG. 6 is an exploded view showing the x-ray sources 104 illustrating a batch packaging method in accordance with the present invention. As with most micromachined structures, the cost and complexity of the packaging process are serious issues. A plurality of x-ray sources may be fabricated simultaneously. Each of the x-ray sources 104 is made by bonding three separate layers (i.e., the anode layer 212, a spacer layer 226, and the emitter layer 216) in a vacuum system. The anode and emitter layers 212 and 216 are shown with a plurality of anodes and emitters 214 and 218 formed thereon, respectively. Portions of the spacer layer 226 have been removed to show the inner details. The spacer layer 226 comprises walls 208 and a clip 118 for each of the anode-emitter pairs. The spacer layer 226 comprises, for example, quartz, and can be formed by etching or preferably by laser machining. The three layers are bonded in an anodic bonding process, which takes place in a vacuum. Once the three layers have been vacuum sealed, individual x-ray sources 104 are diced along the cleaving lines 224 using a laser cutting process.

Although the x-ray catheter device 100 of the present invention has been described using the x-ray source 104 shown in FIG. 5, the present invention can be used with any type of miniature x-ray source, including electrically and thermally activated vacuum sealed x-ray sources, that can be packaged as shown in FIG. 6.

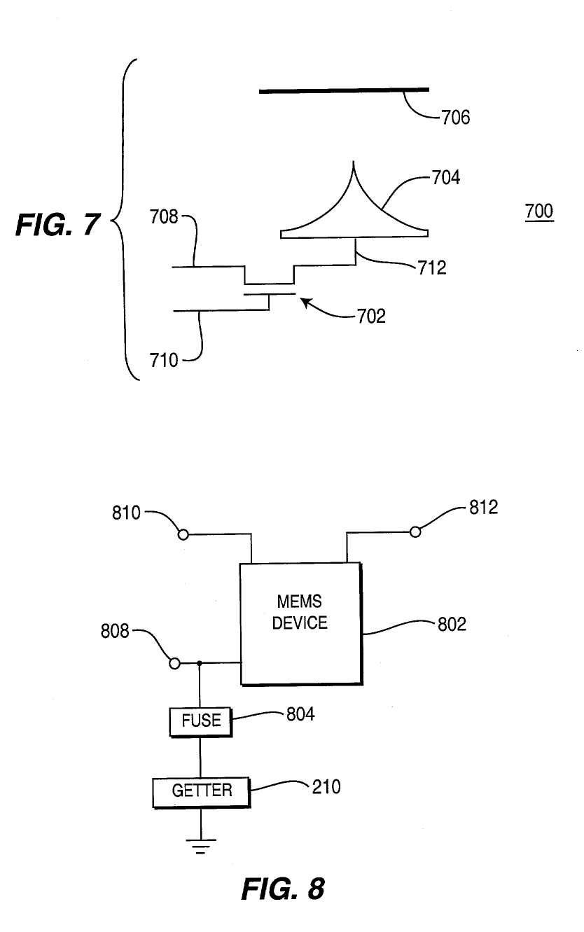

FIG. 7 is a schematic diagram showing an alternative configuration of an x-ray source 700. The x-ray source 700 comprises an anode 706, and emitter 704, and a transistor 702. The x-ray source 700 is formed substantially as described above with respect to FIG. 5, with the removal of the gate and the addition of the transistor 702. In gated x-ray sources, the electric field near the emitter is strongly affected by the microscale geometry of the emitter and the distance between the emitter and the gate. As such, the emission of current of field emitters typically varies from emitter to emitter. The transistor 702 is a semiconductor transistor integrated within the emitter layer, where a drain 712 is coupled to the emitter 704, and the gate 710 and source 708 are coupled to electrodes on the package. Semiconductor transistors are much easier to fabricate uniformly, and thus the present invention advantageously avoids having to reproduce exactly the same emitter-gate structure topology/geometry for every emitter-gate structure under the process.

In operation, the functionality of the gate is replaced by the regulation transistor 702. A voltage potential on the order of 10 to 100V is applied to the source 708. A control voltage potential is applied to the gate 710 on the order of 100 to 200V. When a high voltage is applied to the anode 706, electrons are drawn from the emitter 704. The transistor 702 controls the current flowing through the emitter. Current flow depends on the voltage applied to the gate 710. As such, the current that is coupled to the emitter 704 is regulated, rendering the x-ray source 700 more reliable that gated x-ray sources.

FIG. 8 is a block diagram showing an electrical connection of a getter material to a vacuum-sealed MEMS devices, such as an x-ray source used with the present invention. Specifically, a MEMS device 802 comprises three contacts 808, 810, and 812, (e.g., an anode, an emitter, and a gate contact of an x-ray source). Although the MEMS device 802 is described as having three contacts, the present invention is applicable to MEMS devices having any number of contacts. A fuse 804 is electrically coupled to an existing contact, for example, contact 808. The getter material 210 is electrically coupled to the fuse 804. The fuse 804 comprises a micromachined fuse that can be fabricated during the MEMS process. For example, the fuse can be a polysilicon fuse that evaporates in a few minutes with a few milliamperes of current. The getter material 210 can be deposited by the technique of screen printing.

In operation, a current path is created through the fuse 804 and the getter 210 to ground. The current path is parallel with a current path already existing on the contact 808 for the MEMS device 802. The additional current path passes through the fuse and activates the getter material 210. The fuse 804 heats up and slowly evaporates, and finally disconnects the getter material 210 from the contact 808, isolating it from the MEMS device 802. The MEMS device 804 must be able to tolerate a small voltage applied to the contact 808 SO that the getter can be activated. For x-ray sources, the fuse and getter 804 and 210 can be coupled to the gate contact. As described above, the gate voltage is typically greater than 10 volts, and therefore can have the getter 806 tied to the gate contact.

In this manner, the present invention requires no additional electrical connection on the MEMS device 802 for activating the getter material. For MEMS x-ray sources, such as that shown in FIG. 5, is desirable to minimize the number of contacts and electrical lines due to the small size of the x-ray source. Coupling the getter material 210 to an existing contact eliminates the need for the addition of a getter contact. In an alternative embodiment of the invention, multiple stages of fuses can be designed using different series resistance values to allow some getter material to be activated first, and reserve other getter material to be activated when a high vacuum is absolutely required. As such, the present invention should increase the shelf lifetime of the vacuum package.

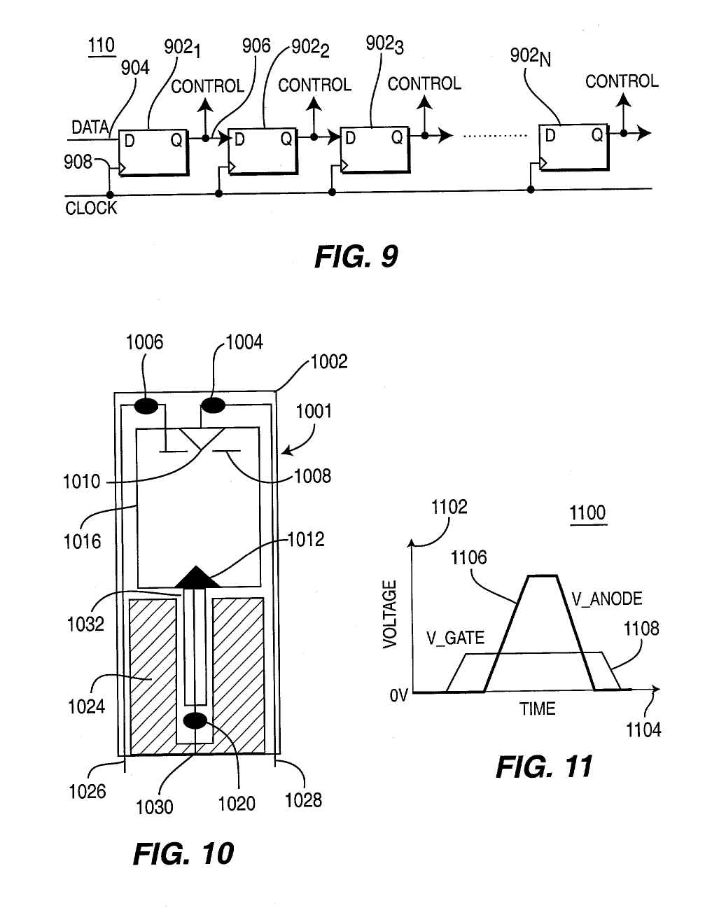

FIG. 9 is a block diagram showing an example of the electrical bus line circuit 110 of FIG. 2. The electrical bus line circuit 110 comprises N D-register circuits 902₁ through 902_{N} (collectively 902), where N is an integer that represents the total number of x-ray sources 104 in the chain. Each D-register circuit 902 comprises a high voltage circuit having a data port 904, and output port 906, and a clock port 908, as are known in the art. The D-register circuits 902 are arranged such that the output port 506 of D-register 902₁ is coupled to the input port 904 of D-register 902₂, and the output port 906 of the D-register 902₂ is coupled to the input port 904 of the D-register 902₃, and so on until the last D-register in the chain. A single clock signal is coupled to the clock port 908 of each D-register circuit 902. The output port 906 of each D-register is coupled to a respective x-ray source 104 in the source chain.

In operation, the output port 906 of each D-register 902 acts as a control signal for each x-ray source 104. As there could be numerous x-ray sources 104 in the chain, it is impossible to have separate controls for each x-ray source 104 (either gate voltage for each electrical source, or current control for each thermionic source). Control data can be passed in for each x-ray source 104 and actively turn each of them on or off using the clock signal, which is generated via the control circuitry 112. The electrical bus line circuit 110 requires the addition of two electrical lines 117 (a data line and a clock line) to the flexible cord 116. In the embodiment of the invention where the x-ray sources 104 are fabricated using a MEMS process, the electrical bus line circuit 110 can be processes at the same time on the same substrate, which would avoid the need of an extra bonding process. Although the electrical bus line circuit 110 is shown in FIG. 1 as being outside the catheter 102, those skilled in the art understand that the circuit 110 can be fabricated within the x-ray sources 104 themselves.

FIG. 10 is a cross-sectional view showing an x-ray source 1001 disposed in a catheter 1002 having a geometry that reduces flashover. The x-ray source 1001 comprises a vacuum chamber 1016, an anode 1012, an emitter 1010, and a gate 1008 is disposed in a distal portion of a catheter 1002. The walls defining the vacuum chamber 1016 comprise, for example, quartz. Electrical lines 1026, 1028, and 1030 are disposed along the catheter and coupled to a power source (not shown). Electrical lines 1026 and 1068 are coupled to contacts 1006 and 1004, respectively. Electrical line 1030 is coupled to contact 1020. Contacts 1006 and 1004 are electrically coupled to the gate 1008 and the emitter 1010, respectively. The contact 1030 is electrically coupled to the anode 1012. The vacuum chamber 1016 includes a pigtail 1032, which extends through a central portion of a dielectric material 1024, such as plastic.

In operation, a high voltage is applied to the electrical line 1030 for the anode 1012, a low voltage is applied to the electrical line 1026 coupled to the gate, and the electrical line 1028 coupled to the emitter is grounded. The operation of field emissive x-ray device is described above with respect to FIG. 5.

In accordance with the present invention, the dielectric material is selected that flashover through the dielectric is eliminated. The pigtail 1032 extending from the vacuum chamber 1016 results in an extended distance between the high-voltage contact 1020 and the electrical lines 1026 and 1028. Thus, the distance between the high voltage contact 1030 is now on the order of several millimeters. Thus, the chance of flashover is greatly reduced. Moreover, the use of the pigtail 1032 allows for enough room to add the dielectric 1024 around the pigtail 1032.

FIG. 11 is a graph 1100 showing a high-voltage driving technique to reduce flashover. Axis 1102 represents the voltage while axis 1104 represents time. The present invention is a method of driving an x-ray source, or a plurality of x-ray sources as described with respect to FIGS. 2 and 5. In accordance with the present invention, the anode voltage is first ramped up to the prebreakdown point and back down a predetermined amount of times. This ramping (not shown in FIG. 11) will apply a spark-conditioning effect, which is the in situ cleaning of the x-ray device such that the sources of prebreakdown current and micro-discharges are safely quenched. As a result, the sources of instability, such as surface roughness of the anode and emitter layers that can contribute to the breakdown, are reduced.

After the conditioning, control of the gate and anode voltage of the x-ray source(s) is as shown in FIG. 11. The gate voltage 1108 is turned on first to induce electron emission current. Then, after electron emission starts, the anode voltage 1106 is ramped to its designed value (typically 20 kV). Since the electron emission has already started, the high-voltage/field stress will be released by the electron current from the emitter to the anode of the x-ray source(s). To turn off the x-ray source(s), the anode voltage 1106 before turning down the gate voltage 1108. Although the high-voltage driving scheme of the present invention may cause some leakage current from the emitter to the gate at the beginning and the end of the operation, the tradeoff is worthwhile as the risk of flashover is reduced. The rise and fall times of the ramps for both the gate voltage 1108 and the anode voltage 1106 are on the order of seconds, for example, 1 second. The duration of the pulse of both the gate and anode voltages 1108 and 1106 are dictated by the particular procedure and are on the order of minutes, for example, 5-30 minutes.

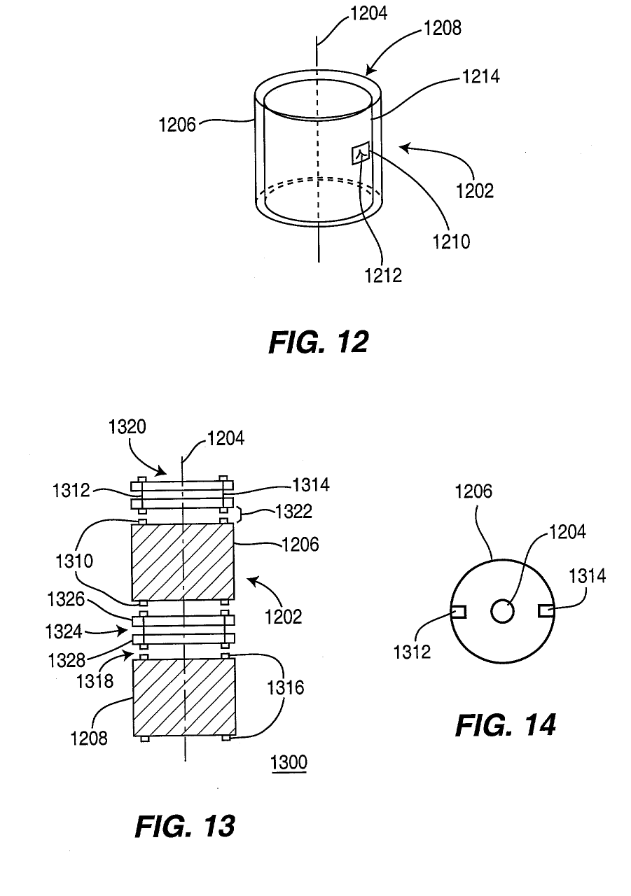

FIG. 13 shows an alternative embodiment of a chain of x-ray sources 1300 suitable for use in a catheter. Specifically, FIG. 12 is an isometric view of a cylindrically symmetric field emission x-ray source 1202. FIG. 13 is a cross-sectional view of the x-ray chain 1300 showing a plurality of the x-ray sources 1202 chained together. FIG. 14 is a top plan view of the x-ray catheter device 1300.

As shown in FIG. 12, the cylindrically symmetric x-ray source 1202 comprises a glass tube 1206, a high-voltage anode 1204 disposed in the center of the glass tube 1206, and a multiplicity of emitters 1208 on the wall of the glass tube 1206. The glass tube 1206, for example, has a diameter between 1 and 3 millimeters and the thickness of the wall of the glass tube 1206 is in the range of 50 to 100 microns. The anode 1204 comprises, for example, a tungsten filament. In one embodiment, the multiplicity of emitters 1208 comprise graphite emitters 1212 formed on a silicon substrate 1210. The silicon substrate 1210 is lapped or etched down to a thickness between 10 and 100 microns. The silicon substrate 1210 is then transferred to a thin sheet of plastic 1214, and the sheet of plastic 1214 is adhesively mounted to the inner wall of the glass tube 1206. Alternatively, the multiplicity of emitters 1208 comprise metal emitters deposited on a flexible plastic substrate 1214 using a low temperature process. In other embodiments, crystalline silicon transferring technology used in making displays in quartz or plastic can be used to form the multiplicity of emitters 1208. If desired, the multiplicity of emitters 1208 can share a common gate electrode (not shown).

In operation, the x-ray source 1202 is held under a vacuum and a voltage potential between 10 and 30 kV is applied to the anode 1204. Electrons escape the emitters 1208 and are accelerated toward, and collected by, the anode 1204 at the center of the glass tube 1206. The electrons strike the anode 1204, producing x-rays. The generated x-rays will then travel through the thin layers of the emitters 1208, as well as the wall of the glass tube 1206. Thus, the present invention provides a cylindrical x-ray source with an even distribution of x-ray radiation.

As shown in FIG. 13, the cylindrically symmetric x-ray source 1202 can be connected together (chained) with other sources 1202 to form the x-ray source chain 1300. The chain 1300 can be disposed in a catheter to form an x-ray catheter device. The chain 1300 comprises a plurality of x-ray sources 1202 and a spacer 1324 between each x-ray source 1202. Each spacer 1324 comprises a top glass tube 1326 and a bottom glass tube 1328. The top and bottom glass tubes 1326 and 1328 collectively form a double tandem spacer 1324. Each spacer 1302 has the same diameter as that of the glass tube 1206 and includes a center hole having a diameter such that the anode 1204 can pass therethrough. The distance between the top and bottom glass tubes 1326 and 1328 is, for example, between 0.5 and 1 millimeter, and the total height of the double tandem spacer 1324 is between 1 and 4 millimeters.

Each spacer further comprises a gate conductor 1312 (if required) and an emitter conductor 1314. The conductors 1312 and 1314 are buried or bonded to the inside wall of both the top and bottom glass tubes 1326 and 1328 and are exposed at the top and bottom surfaces of each spacer 1324. Each of the x-ray sources 1202 includes exposed gate and emitter contacts 1310 and 1316. The anode 1204 is disposed longitudinally throughout the center of each x-ray source 1202 and each spacer 1324. The chain 1300 is formed in a vacuum as follows: The gate and emitter conductors 1312 and 1314 are bonded to their respective gate and emitter contacts 1310 and 1316 to form a metal-to-metal bond 1318. Each spacer 1324 is bonded with the anode 1204 at the center hole via a metal-to-glass bond 1320. Finally, each x-ray source 1202 is bonded with their respective top and bottom glass tubes 1326 and 1328 of their respective spacers 1324 via a glass-to-glass bond 1322. After the bonding processes, the hollow tube (x-ray sources 1202 and spacers 1324 together) is encapsulated with a flexible dielectric material, such as quartz, to maintain a vacuum. The double tandem design of the spacers 1324 provides flexibility for the chain 1300 to make turns, such as those necessary in x-ray catheter applications. The bonds are formed via a anodic bonding process that takes place in a vacuum.

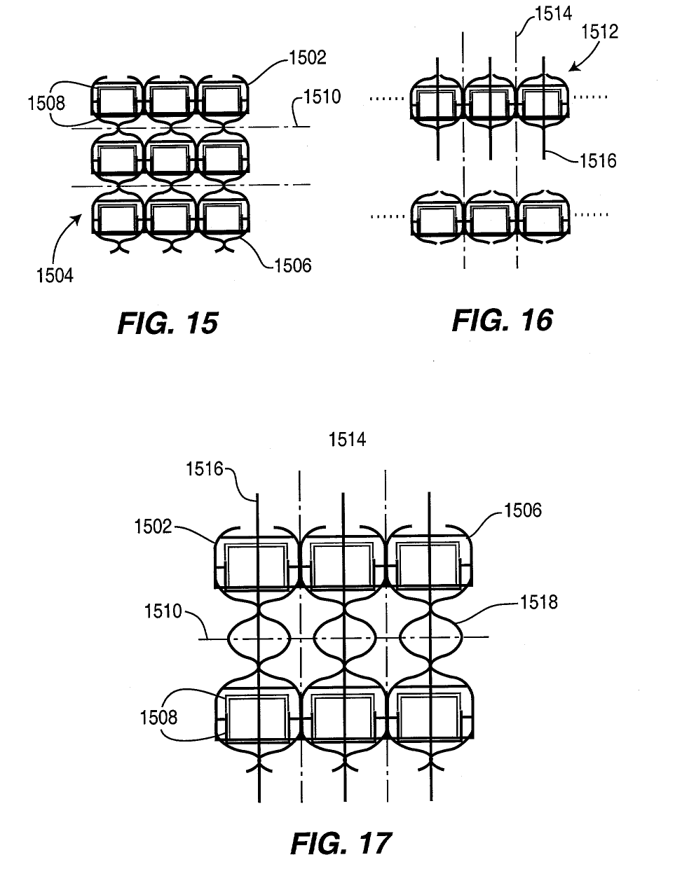

FIGS. 15-17 show a plurality of cylindrically symmetric x-ray sources 1202 being fabricated using batch processing. As shown in FIG. 15, half glass tubes 1502 are fabricated in a batch fabrication process. The half glass tubes 1502 are aligned to form an array having N×N half tubes 1502, where N is an integer between 10 and 1000. The N×N half tubes 1502 form a substrate 1504. Emitters 1506 and contact metal lines 1508 are processed and deposited on the substrate 1504 for each half glass tube 1502, as described above with respect to FIG. 12. Contact metal lines 1508 can also be deposited via a shadow mask after the emitters 1506 are processed. After the emitters 1506 are processed, the substrate 1504 is cleaved along horizontal lines 1510 using a laser cutting process. The result is arrays of 1×N half glass tubes 1512 as shown in FIG. 16.

For simplicity, on two of the 1×N arrays 1512 are shown. After the 1×N arrays 1512 are formed, anodes 1516 are disposed in the center of each half glass tube 1502 for one of the 1×N arrays 1512. The other 1×N array 1512 is then aligned and bonded in a vacuum with the 1×N arrays having the anodes 1516 to form a 1×N array of x-ray devices. The 1×N array of x-ray devices is then sliced along vertical lines 1514 to produce N individual x-ray devices. The anode 1516 is exposed for connection as described above with respect to FIG. 12. The contact metal lines 1508 for the emitters and the gate are alongside the bond seal of the two half glass tubes 1502, where silver epoxy or other bonding materials can be used to secure the contacts.

FIG. 17 shows the x-ray sources of FIG. 12 being fabricated by an alternative method of batch processing. In the present embodiment, the half glass tube substrate 1504 is different from that of FIG. 15 in that an empty pocket 1518 is formed between rows of the half glass tubes 1502. Two of such substrates 1504 can be bonded together face to face with an anode 1516 sandwiched therebetween. In this manner, an N×N array of x-ray tubes is packaged together in a parallel process. After the bonding, the two substrates are sliced along vertical lines 1514 and horizontal lines 1510 to form a total of N² x-ray sources. The empty pockets 1518 allow for easy access to the anode 1516 for slicing purposes.

While foregoing is directed to the preferred embodiment of the present invention, other and further embodiments of the invention may be devised without departing from the basic scope thereof, and the scope thereof is determined by the claims that follow.

1. A catheter for emitting x-ray radiation comprising:
a flexible catheter shaft having a distal end defining a lumen;
a plurality of x-ray sources disposed in the lumen proximate the distal end; and
a control circuit for individually activating specific ones of the plurality of x-ray sources.

2. The catheter of claim 1 wherein each of the x-ray sources comprise:
an anode;
an emitter; and
a spacer, wherein the anode and the emitter are separated by the spacer.

3. The catheter of claim 2 wherein each of the x-ray sources further comprises an insulating layer formed on the emitter, and a gate formed on the insulating layer.

4. The catheter of claim 2 wherein each of the x-ray sources further comprises a transistor formed therein.

5. The catheter of claim 1 wherein the electrical bus line circuit comprises a D-register circuit for each of the plurality of x-ray sources, each D-register circuit being integrated within the x-ray source.

6. The catheter of claim 1 further comprising:
a flexible cord formed of a dielectric material disposed longitudinally throughout the lumen, the flexible cord having a plurality of electrical conductors embedded in the dielectric material; and
a clip-on connector for each of the plurality of x-ray sources for mechanically and electrically coupling each of the x-ray sources to the flexible cord.

7. The catheter of claim 6 wherein each clip on connector comprises:
a flexible extension cantilevered from the flexible cord having a front surface, a back surface, and a top surface;
a plurality of contacts disposed on at least one of the front and top surfaces;
an electrical line extension for each of the plurality of contacts;
a plurality of protrusions disposed on at least one of the front and back surfaces; and
a clip bonded to the x-ray source, wherein the clip mates with the flexible extension such that the plurality of protrusions create a mechanical force on the clip to both secure the x-ray source to the flexible extension and creates an electrical contact between the plurality of contacts and the x-ray source.

8. The catheter of claim 2 wherein each of the plurality of x-ray sources comprises a getter deposited on at least one of the anode and the emitter.

9. The catheter of claim 8 wherein each of the plurality of x-ray sources further comprises a fuse coupled between the gate and the getter.

10. The catheter of claim 1 wherein each of the plurality of x-ray sources comprises:
a glass tube;
an anode disposed in the center of the glass tube and extending longitudinally therethrough; and
a multiplicity of emitters formed on a substrate, the substrate being mounted to an interior wall of the glass tube surrounding the anode.

11. The catheter of claim 10 further comprising a glass spacer disposed between each of the plurality of x-ray sources, each spacer having at least one conductor formed therein, wherein each of the plurality of x-ray sources is bonded to a respective glass spacer.

12. A method of driving an x-ray source disposed in a catheter having an anode, an emitter, and a gate comprising:
applying a first voltage potential to the gate to induce electron emission current; and
ramping up a second voltage potential applied to the anode.

13. The method of claim 12 further comprising:
ramping down the second voltage potential applied to the anode; and
removing the first voltage potential from the gate to stop the electron emission current.

14. The method of claim 12 further comprising conditioning the x-ray device by repeatedly ramping up and down a third potential applied to the anode.

15. A method of fabricating a plurality of x-ray sources comprising:
forming a plurality of anodes on a first substrate;
forming an emitter for each of the plurality of anodes on a second substrate, defining a plurality of anode-emitter pairs;
forming a spacer layer having a first surface and a second surface and having a chamber portion and a clip portion for each of the plurality of anode-emitter pairs; and
bonding the first substrate to the first surface of the spacer layer and the second substrate to the second surface of the space layer in a vacuum, wherein each of the plurality of anode-emitter pairs are disposed in a respective one of the chamber portions and are bonded to a respective one of the clip portions to form the plurality of x-ray sources.

16. The method of claim 15 wherein the step of forming a spacer layer comprises laser machining a quartz substrate to form the chamber and clip portions.
